(19) United States
(12) Patent Application Publication
(10) Pub. No.: US 2014/0208629 A1
(43) Pub. Date: Jul. 31, 2014

(54) FISHING LURE CONSTRUCTION AND METHOD

(71) Applicant: Tom Watanabe, Fountain Valley, CA (US)

(72) Inventor: Tom Watanabe, Fountain Valley, CA (US)

(21) Appl. No.: 14/166,801

(22) Filed: Jan. 28, 2014

Related U.S. Application Data
(60) Provisional application No. 61/758,045, filed on Jan. 29, 2013.

(51) Int. Cl. A01K 85/08; A01K 85/18

(52) U.S. Cl. CPC A01K 85/08; A01K 85/18
USPC 43/42.32

(57) ABSTRACT

A fishing lure includes a head formed of mating mirror image head portions defining an interior cavity therein. A fish hook is captivated between the mating head portions such that the eyelet thereof extends forwardly and the bend extends downwardly with the point thereof extending forwardly. A plurality of elongated filamentary elements are looped about the hook shank within the head and extend outwardly from the head.

### CROSS-REFERENCE TO RELATED APPLICATION

This application claims the benefit of and priority under 35 U.S.C. 119(e) of U.S. Provisional Patent Application No. 61/758,045 entitled FISHING LURE CONSTRUCTION AND METHOD, filed Jan. 29, 2013 in the name of Tom Watanabe, the disclosure of which is incorporated herein by reference.

### FIELD OF THE INVENTION

This invention relates generally to fishing lures and particularly to methods and constructions for the fabrication thereof.

### BACKGROUND OF THE INVENTION

The sport of fly fishing has existed for many years and has grown to enjoy great popularity. While each fly fisherman tends to develop and refine a personalized technique for fly fishing, basically the sport involves using a long flexible rod having reel upon which a quantity of fishing line is received. The reel is typically supported at the handle end of the fly fishing rod and supports the fishing line upon a rotatable reel. A plurality of eyelets supported along the extent of the flexible rod are used to guide the fishing line from the reel to and beyond the end of the fly rod. A fishing lure is secured to the outer end of the fishing line.

Once again, techniques vary somewhat among practitioners, however, for the most part the process of fly fishing involves working a substantial length of fishing line and the fishing lure into the air above the fisherman in preparation for depositing the fishing lure at a selected portion of the stream or other body of water being fished. To accomplish this, the fisherman moves the rod back and forth in a whip-like motion taking advantage of the extreme flexibility and length of the rod while an increasing length of fish line is played out from the reel. When properly done, a substantial length of fishing line supporting the fishing lure at its extreme end is kept aloft above the fisherman by the whipping motion of the fly fishing rod. At the optimum moment and through the use of substantial timing, the fisherman then snaps the rod forward and holds it to cast the entire played out line and lure forwardly and drop the lure upon the water surface. As can be imagined, this process is a matter of considerable skill and timing. As the lure drops to the water surface, it typically floats upon the water surface or slightly beneath it to entice a fish. If a fish strikes the hook within the lure snares the fish and the fisherman reels in the snared fish. If no strike occurs, the line is reeled in and the process repeated. As would be anticipated, fishermen utilizing fly fishing apparatus develop a variety of techniques in a given waterway situation. Some prefer to have the lure drop to the surface and mimic an insect which has fallen to the water. Others utilize a drifting technique in which the lure resting upon the water surface is allowed to drift into an area believed opportune for attracting a fish. Other techniques have been developed and each fisherman tends to believe in their particular skill in utilizing the appropriate fishing lure and technique to maximize fishing success.

Fishing lures utilized in fly fishing have assumed a virtually endless variety. Some fly fishing lures are constructed to resemble insects or other attractive creatures while others resemble small fish upon which the sport fish typically feeds. Still other fly fishing lures are fabricated in a variety of fanciful shapes without particular attempt to resemble a naturally occurring creature. In most instances, such “unnatural” appearing fishing lures are constructed to assume shapes and colors believed attractive to fish.

In most instances, fly fishing lures are constructed utilizing a common basic fly fishing lure construction technique. In most instances, a hook is secured within a convenient vice or the like and a plurality of elements such as feathers, streamers or the like are secured to the shank portion of the fish hook. Often, a twine is wrapped about the shank of the fish hook to secure the feathery wispy elements of the fish lure. In some instances, a quantity of adhesive such as varnish or epoxy is deposited upon the twine and hook shank to waterproof and fix the attachment.

Many fly fishermen and other enthusiasts of the fly fishing arts exhibit particular enjoyment in the creation and fabrication of the various fishing lures. Many such participants enjoy substantial fame and reputation in the circle of fly fishing enthusiasts. In addition, the prominence of the fly fishing sport and the challenges of constructing and creating novel fly fishing lures has resulted in a substantial art area for fly fishing lures in which the creativity and novelty of the lures as art objects is elevated and appreciated. In such instances, the artistic quality of the fly fishing lures transcends the effectiveness of the lures in their ability to attract and snare fish.

Notsurprisingly, a substantial industry and art form which enjoys great popularity and participation surrounding the sport of fly fishing and the creation and construction of fly fishing lures has arisen. Faced with this growing popularity and enthusiasm, there arises in the art a need for improved constructions and methods of fabrication for creating and producing fly fishing lures.

### SUMMARY OF THE INVENTION

The present invention fishing lure construction and method provides a fly fishing lure construction in which a pair of half portions combining to form a head are fabricated in mirror image. The mirror image head portions are joined to form a head such as a small fish head utilizing an adhesive such as epoxy resin or the like which is impervious to water. The head portions captivate a portion of the shank of an otherwise conventional fish hook such that the eyelet of the fish hook extends forwardly from the head portion while the curved hook and sharp barb of the fish hook extend beneath the rear portion of the head. The head portions in addition to captivating a fish hook shank further captivate a plurality of extending filamentary elements to provide a feather-like array of elongated filamentary elements extending rearwardly along the rear edge of the head portion. In its preferred fabrication, an adhesive epoxy resin secures the head portions. The attractiveness of the fishing lure is further enhanced by a pair of simulated fish eyes supported on each of the head portions. The appearance is still further enhanced by the use of glitter material within the head portions. While the head portions may be fabricated using virtually any construction technique, it has been found optimum to mold each of the head portions from a suitable material such as epoxy resin or the like. In its preferred fabrication, the material selected for the head portions is primarily clear with the above-mentioned glitter elements mixed therein. Coloration of the head portions to closely resemble the coloration of a typical fish head also is utilized.

Thus, the present invention provides a fishing lure comprising: a fish hook having a shank, an eyelet at one end of the shank, a bend at the remaining end of the shank and a barbed point on the bend; a plurality of generally filamentary elements forming loops about the shank and having extending ends; a head formed of a pair of generally mirror image head portions each of the head portions defining a top edge, a front edge, a rear edge and an interior, the head portions head portions each further including a first notch between the top edge and the front edge and a second notch; and a quantity of adhesive material deposited upon the shank and the loops, the fish hook and a portion of the filamentary elements being captivated between the mirror image head portions such that the shank extends through the first notch supporting the eyelet forward of the head and such that the bend extends below the head and the extending ends of the filamentary elements extend rearwardly beyond the rear edges of the head portions.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a side elevation view of a fishing lure constructed in accordance with the present invention;

FIG. 2 sets forth an intermediate stage of fabrication of the present invention fishing lure in which one head portion is yet to be assembled;

FIG. 3 sets forth a perspective assembly view of the present invention fishing lure illustrating its construction and novel method of fabrication;

FIG. 4 sets forth a perspective view of a typical mold utilized in fabricating the present invention fishing lure;

FIG. 5 sets forth a side elevation view of an alternate embodiment of the present invention fishing lure;

FIG. 6 sets forth a side elevation view of a further alternate embodiment of the present invention fishing lure; and

FIG. 7 sets forth a side elevation of a still further alternate embodiment of the present invention fishing lure.

### DESCRIPTION OF THE PREFERRED EMBODIMENTS

By way of overview, the present invention fishing lure construction and method provides a fishing lure suitable for the sport of fly fishing which avoids the tedious and difficult task associated with conventional fishing lure fabrication. The novel construction and method utilized embodies a pair of mirror image head portions configured to be joined by adhesive attachment to form a head portion. In many instances, the head portion resembles the head of a fish. However, other appearances may be utilized without departing from the spirit and scope of the present invention. The head portions are joined utilizing an adhesive attachment to captivate the shank portion of an otherwise conventional fish hook together with a plurality of elongated filamentary or feathery elements. In this manner, the entire fishing lure may be assembled quickly and easily by simply adhesively joining the head portions to captivate the fish hook shank and filamentary elements. The appearance and attractiveness of the present invention fishing lure is further enhanced by utilizing a clear molded material to form the head portions within which a quantity of glitter-type particles are suspended and captivated. The appearance is still further enhanced by the application of a pair of simulated fish eyes and suitable coloration of the fish head portions.

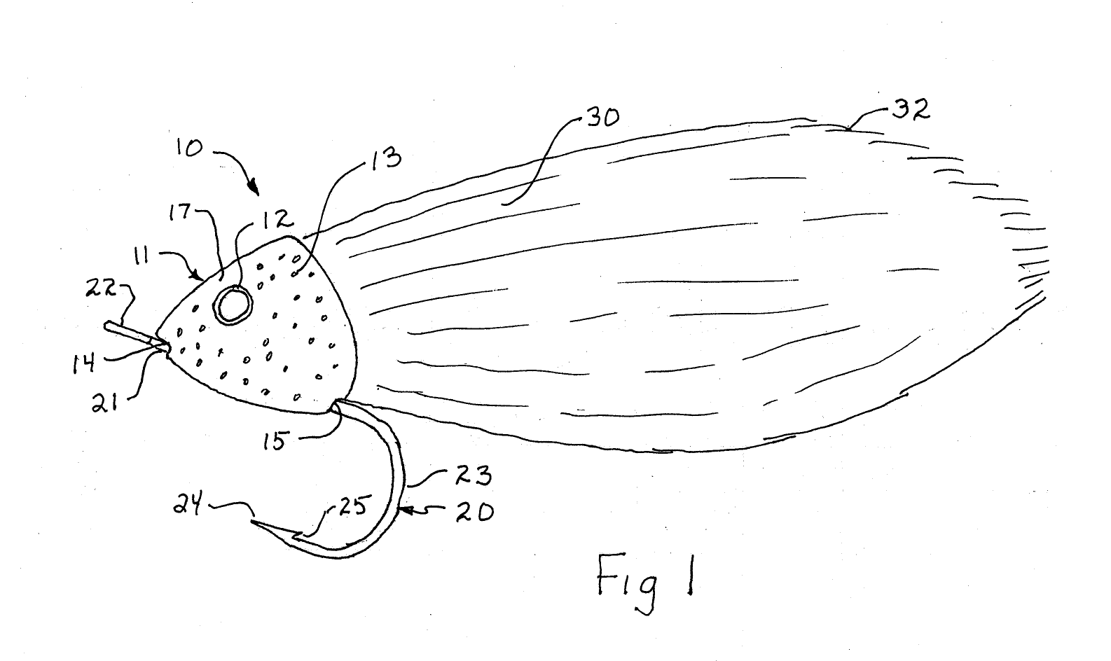

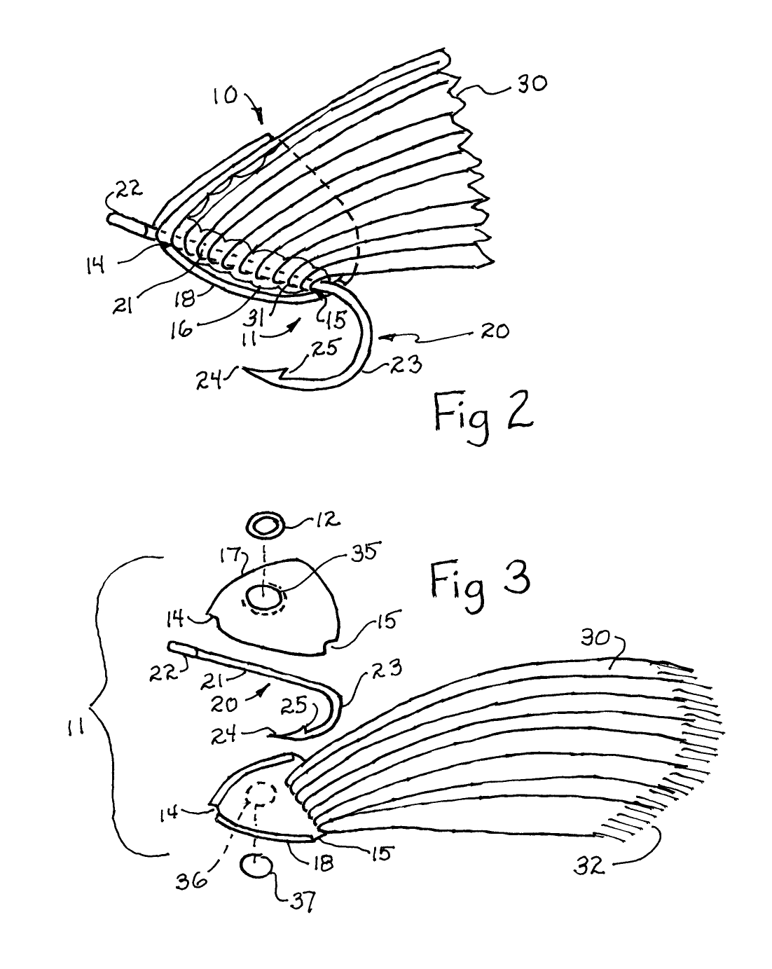

More specifically and with reference to FIG. 1, a fishing lure constructed in accordance with the present invention and generally referenced by numeral 10 is shown in side elevation view. Fishing lure 10 includes a molded head 11 fabricated of half portions 17 and 18 (head portion 18 better seen in FIG. 3). Head portion 17 supports a simulated fish eye 12 and is molded from a material supporting a plurality of glitter particles 13. Head 11 further defines a front notch 14 and a rear notch 15. In accordance with an important aspect of the present invention, head portions 17 and 18 are joined to captivate the shank portion of a fish hook. Thus, as is seen in FIG. 1, a fish hook 20 fabricated in accordance with conventional fabrication techniques includes an elongated shank portion 21, an eyelet 22 and a bend 23. The remaining end of fish hook 20 terminates in a sharpened point 24 and a barb 25. Thus as is better seen below in FIG. 2, shank 21 of fish hook 20 is captivated within head 11 as head portions 17 and 18 are joined. Suffice it to note here that shank 21 passes through the lower portion of head 11 and is secured therein. Head 11 is formed in a generally triangular shape. However, it will be apparent to those skilled in the art that the head of the present invention fishing lure may be fabricated in alternative shape, such as the rounded shape shown in FIG. 7, without departing from the spirit and scope of the present invention.

As is better seen in FIG. 2, fishing lure 10 further includes a plurality of elongated filaments grouped in bundles and wrapped about the shank of hook 20 within head 11 and extending rearwardly from head 11. Filaments 30 may be fabricated utilizing a variety of materials selected to have a lightweight “wispy” characteristic similar to fletchings or feathers or the like. In the embodiment shown in FIG. 1, filaments 30 comprise elongated plastic threads preferably having varied coloration and a shiny reflective character. However, it will be apparent to those skilled in the art that a variety of materials may be substituted for filaments 30 without departing from the spirit and scope of the present invention. Thus, in accordance with the present invention, fishing lure 10 assumes a novel shape and is constructed in accordance with a novel fabrication to provide an interesting and attractive fishing lure.

FIG. 2 sets forth an intermediate stage of fabrication of the present invention fishing lure. As mentioned above and as is shown in FIG. 3, fishing lure 10 includes a head 11 formed of a pair of head portions 17 and 18. Returning to FIG. 2, head portion 18 is shown for fishing lure 10 while head portion 17 is yet to be assembled. Thus, as described above, fishing lure 10 includes a head portion 18 having a front notch 14 and a rear notch 15 formed therein. Fishing lure 10 further includes a conventional fish hook having a shank 21 received within head portion 18 and extending between notches 14 and 15. In accordance with the present invention fabrication, shank 21 of hook 20 is secured by adhesive material 16. Hook 20 further includes an eyelet 22 extending forwardly from notch 14 which is used in securing a conventional fish line or leader (not shown). In further accordance with the present invention, a plurality of elongated filaments 30 are grouped in bundles which are looped about hook shank 21 and extend rearwardly from the rear portion of head portion 18. Interior loops of each filament bundle are wrapped around shank 21 and secured by adhesive material 16. Once the assembly shown in FIG. 2 is completed, adhesive 16 is deposited along the upper edge of the uppermost filament bundle and head portions 17 and 18 are secured thereto by adhesive material 16. Once again, it will be noted that shank 21 of hook 20 and interior loops of filamentary elements 30 are captivated within head 11 and secured by the joining of head portions 17 and 18 utilizing adhesive material 16.

FIG. 3 sets forth a perspective assembly view of the present invention fishing lure. As described above, fishing lure 10 includes a head 11 formed of mirror image head portions 17 and 18. Head portions 17 and 18 form front notch 14 and rear notch 15 when joined together. Head portion 17 further includes an eye platform 35 upon which a simulated fish eye 12 is secured by adhesive attachment. Similarly, head portion 18 includes an eye platform 36 upon which a simulated fish eye 37 is secured by adhesive attachment. Fishing lure 10 further includes a conventional fish hook 20 having a shank 21, an eyelet 22 and a bend 23. Bend 23 terminates in a sharp point 24 and a barb 25. Fishing lure 10 further includes a plurality of elongated filamentary elements 30 arranged in bundles each having interior loops 31 which are wrapped about hook shank 21 and outer ends 32 extending from head portions 17 and 18.

In operation, the initial configuration shown in FIG. 2 is achieved by wrapping each bundle of filaments 30 around hook shank 21 and thereafter positioning shank 21 of fish hook 20 between notches 14 and 15. As mentioned above, adhesive material deposited upon shank 21 and the upper filament bundle along head portion 18. The assembly is completed by mating head portion 17 with head portion 18 to contact the deposit of adhesive material within head portion 18 and to captivate shank 21 of fish hook 20 together with loops 31 of filamentary elements 30. Following head assembly, simulated fish eye 12 is adhesively attached to eye platform 35 and simulated fish eye 37 is adhesively attached to eye platform 36. Additional enhancements such as coloration or the like may be applied by airbrushing or other techniques as desired.

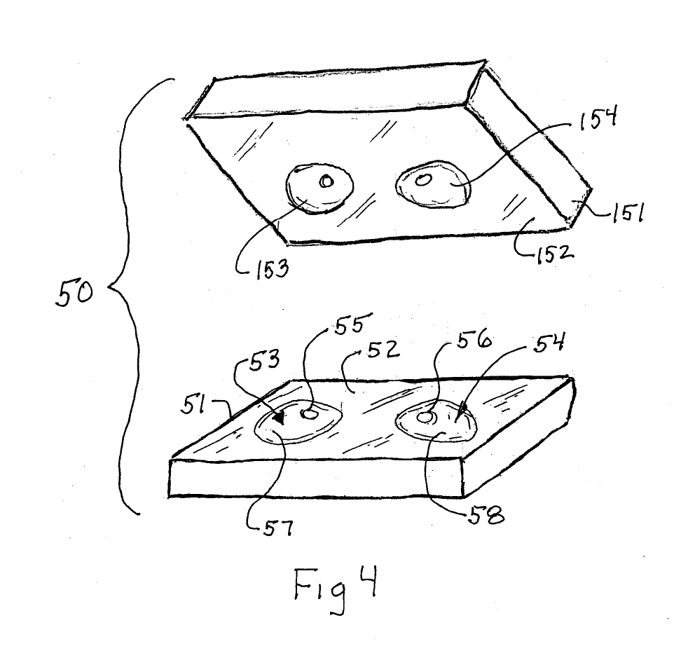

FIG. 4 sets forth an illustrative mold utilized in forming head portions 17 and 18. It will be apparent to those skilled in the art that the mold utilized in FIG. 4 is shown for illustration and other molding techniques such as injection molding or the like may be employed to form head portions 17 and 18 without departing from the spirit and scope of the present invention. Thus, a mold 50 includes a lower mold body 51 preferably formed of a resilient elastic material such as a suitable silicone, rubber or plastic or the like. The essential characteristic for mold body 51 material is sufficient strength and rigidity to maintain the shape of the mold cavities therein while concurrently being sufficiently resilient and elastic to facilitate the easy removal of the molded parts from mold body 51. Mold body 51 further defines a generally planar surface 52 within which a pair of mold cavities 53 and 54 are formed. Mold cavities 53 and 54 are essentially mirror image cavities and are configured and shaped to define the to-be-molded shape of the head portions formed therein. Accordingly, mold cavity 53 defines a recessed cavity having a cavity surface 57 which includes an eye platform 55. Similarly, cavity 54 defines a recessed cavity having a cavity surface 58 which includes an eye platform 56. It will be understood that the character and contour of cavity surfaces 57 and 58 are configured to define the outer surface formed on head portions 17 and 18 (seen in FIG. 3) which are formed to be used in fabricating the present invention fishing lure.

Mold 50 further includes an upper mold body 151 which defines a mold surface 152. A pair of mold projections 153 and 154 are formed to be received within mold cavities 53 and 54 respectively.

In operation, a quantity of moldable material such as clear epoxy or the like (not shown) is deposited into mold cavities 53 and 54 to fill cavities 53 and 54. The utilization of a clear epoxy material facilitates the depositing of glitter particles such as glitter particles 13 shown in FIG. 1 to be molded into the resulting head portions. Additionally, a coloration may be applied to the epoxy material prior to curing or, alternatively, may be applied to the inner and/or outer surfaces of the molded head portion subsequent to curing of the epoxy material. Upper mold body 151 is then placed upon lower mold body 51 such that mold projections 153 and 154 are received within mold cavities 53 and 54 and surfaces 52 and 152 are in contact.

Once the epoxy material deposited within mold cavities 53 and 54 has cured, upper mold body 151 and lower mold body 51 are flexed and separated to ease the resulting molded head portions from mold cavities 53 and 54. It will be understood that some finishing or sanding of mold flash along the outer edges of the formed head portions may be necessary. Once again, it will be apparent to those skilled in the art that while FIG. 4 illustrates a conventional molding technique utilized in forming mirror image head portions such as head portions 17 and 18 shown in FIG. 3, other molding techniques such as injection molding may be employed where higher production volumes and reduced labor costs are desired. A substantial advantage for the molding procedure illustrated in FIG. 4 is found in the ease with which a variety of different head portion shapes may be fabricated without the expense and time delay required in molding techniques such as injection molding or the like. The ability to form molds such as mold bodies 51 and 151 is very convenient for fabricating small numbers of a variety of differently shaped head portions without undue expense and mold fabrication.

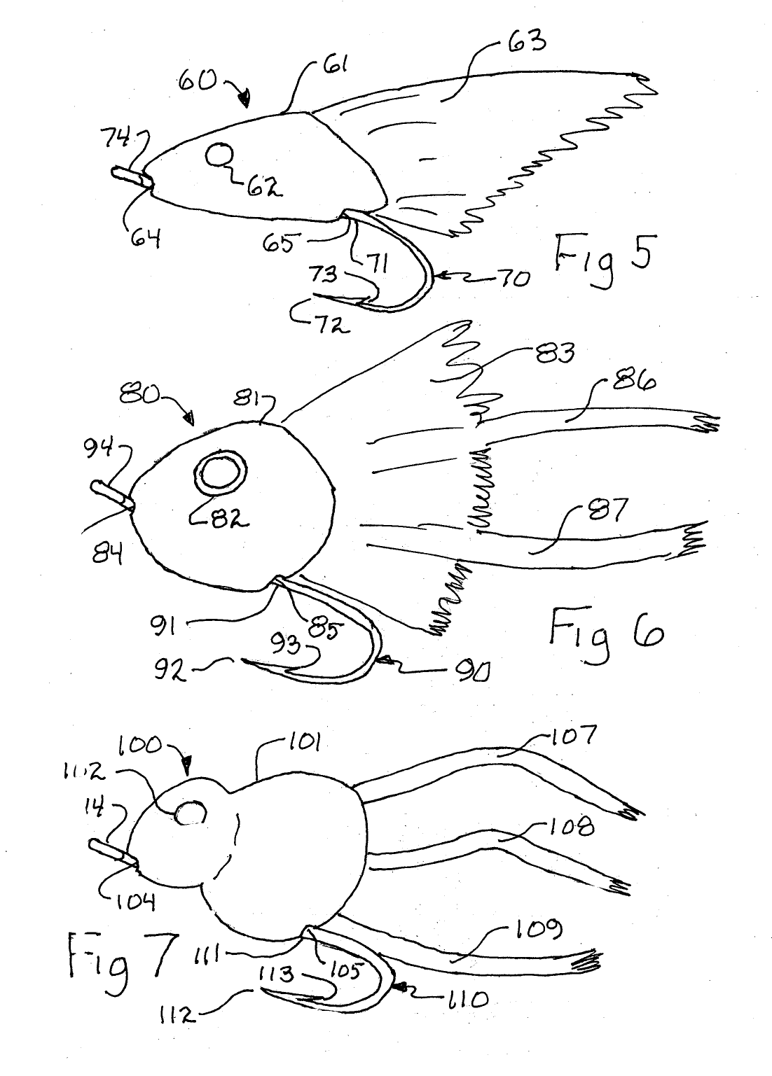

FIGS. 5, 6 and 7 illustrate a plurality of alternate embodiments of the present invention fishing lure construction and method. The objective in FIGS. 5, 6 and 7 is to illustrate the virtually endless variety of different shapes, sizes and configurations of fishing lures which may be fabricated utilizing the present invention construction and method. Thus, it will be understood that while the embodiments shown in FIGS. 1, 5, 6 and 7 illustrate a variety of different fishing lure shapes and sizes, the illustrations therein are not by way of limitation but merely illustration. It will be apparent to those skilled in the art having reviewed the present invention that a virtually endless variety of shapes, sizes and configurations of fishing lures may be provided without departing from the spirit and scope of the present invention.

More specifically, FIG. 5 sets forth a side elevation view of an alternate embodiment of the present invention fishing lure construction and method generally referenced by numeral 60. Fishing lure 60 is fabricated in substantially the same manner as fishing lure 10 set forth and described above. Thus, fishing lure 60 includes a head 61 having an eye 62 which will be understood to be fabricated of a pair of mirror image head portions similar to head portions 17 and 18 shown in FIG. 3 for fishing lure 10. In further similarity to fishing lure 10 set forth and described above, fishing lure 60 includes a conventional fish hook 70 having a generally straight shank 71 together with an eyelet 74. Hook 70 further includes a sharp point 72 and a barb 73. In further similarity to the above-described embodiment, head 61 defines a front notch 64 and a rear notch 65 which accommodate the captivation of shank 71 of fish hook 70. A plurality of trailing elements 63 preferably formed of a plurality of filamentary elongated colorful elements is wrapped about shank 71 of fish hook 70 and received within the rear portion of head 61.

FIG. 6 sets forth a side elevation view of a still further alternate embodiment of the present invention fishing lure generally referenced by numeral 80. Once again, it will be emphasized that fishing lure 80 is substantially different in appearance and shape from fishing lure 10 set forth above but is in fact fabricated utilizing the same inventive construction and method of fabrication. Thus, fishing lure 80 includes a head 81 which is formed of mirror image head portions as described above and which supports a simulated fish eye 82. Head 81 further defines a front notch 84 and a rear notch 85. Fishing lure 80 further includes a conventional fish hook 90 having a shank 91, an eyelet 94 and a sharpened point 92. Fish hook 90 further includes a barb 93. In accordance with the invention, shank 91 of fish hook 90 is captivated within the mating head portions of head 81. To accommodate the captivation of shank 91 within head 81, head 81 includes the above-mentioned notches 84 and 85. Fishing lure 80 further includes a plurality of filamentary trailing elements 83 which are supplemented with elongated streamers 86 and 87. Filamentary elements 83 and elongated streamers 86 and 87 are looped about shank 91 of fish hook 90. The overall appearance of fishing lure 80 differs from fishing lure 10 and fishing lure 60 shown above in FIGS. 1 and 5. However, the fabrication is substantially identical.

FIG. 7 sets forth a side elevation view of a still further alternate embodiment of the present invention fishing lure generally referenced by numeral 100. Fishing lure 100 is fabricated in substantially the same manner as the above-described embodiments of the present invention and thus includes a head and body unit 101 which is formed of mirror image portions similar to the above-described head portions 17 and 18 shown in FIG. 3. Thus, head and body unit 101 supports a simulated eye 102 and defines a pair of notches 104 and 105. A conventional fish hook 110 having an elongated straight shank 111 is received within head and body unit 101 and is captivated therein utilizing the above-described fabrication. Hook 110 further includes an eyelet 114, a sharp point 112 and a barb 113. Fishing lure 100 further includes a plurality of trailing streamers 107, 108 and 109 which are wrapped about shank 111 of fish hook 110 within the rear portion of head and body unit 101. Fishing lure 100 differs substantially from the above-described embodiments of the present invention. However, it will be understood that the fabrication of fishing lure 100 is carried forward in substantially the same manner as described above. The variation within FIG. 7 for fishing lure 100 utilizes a head and body unit 101 in place of the heads utilized in the above-described embodiments. However, it will be understood that head and body unit 101 is formed of a pair of mirror image mating portions which are joined adhesively utilizing the fabrication set forth in FIG. 2 for fishing lure 10. Fishing lure 100 generally resembles an insect-like creature. However, it will be understood by those skilled in the art that a variety of different shapes and sizes may be fabricated without departing from the spirit and scope of the present invention.

What has been shown is a novel fishing lure particularly suited to fly fishing which employs a construction and method of fabrication which is novel and which provides a great variety of attractive and innovative fishing lures. The fishing lure described utilizes a pair of mirror image mating half portions which are joined adhesively to captivate a conventional fish hook together with a plurality of trailing or streaming elements. The entire fabrication lends itself to substantial variety and innovation on the part of the fabricator.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A fishing lure comprising:
a fish hook having a shank, an eyelet at one end of said shank, a bend at the remaining end of said shank and a barbed point on said bend;
a plurality of generally filamentary elements forming loops about said shank and having extending ends;
a head formed of a pair of generally mirror image head portions each of said head portions defining a top edge, a front edge, a rear edge and an interior, said head portions each further including a first notch between said top edge and said front edge and a second notch; and
a quantity of adhesive material deposited upon said shank and said loops,
said fish hook shank and a portion of said filamentary elements being captivated between said mirror image head portions such that said shank extends through said first notch supporting said eyelet forward of said head and such that said bend extends below said head and said extending ends of said filamentary elements extend rearwardly beyond said rear edges of said head portions.

2. The fishing lure set forth in claim 1 wherein said plurality of filamentary elements are grouped in multiple element bundles.

3. The fishing lure set forth in claim 1 wherein said head portions each define an eye platform and wherein each head portion includes a simulated eye secured to said eye platform.

4. The fishing lure set forth in claim 1 wherein said head portions are each generally triangular in shape.

5. The fishing lure set forth in claim 4 wherein said head portions each define generally concave interior surfaces which combine to form an interior cavity within said head when said head portions are joined.

6. The fishing lure set forth in claim 1 wherein said head portions are formed of a molded plastic material.

7. The fishing lure set forth in claim 6 wherein said molded plastic material is transparent and includes glitter particles.

8. The fishing lure set forth in claim 7 wherein said head portions each define outer surfaces and wherein said head portions each further include painted coloration on at least a portion of said outer surfaces.

9. The fishing lure set forth in claim 1 wherein said head portions each define generally concave interior surfaces which combine to form an interior cavity within said head when said head portions are joined.

10. The fishing lure set forth in claim 9 wherein said head portions are formed of a molded plastic material.

11. The fishing lure set forth in claim 6 wherein said molded plastic material is transparent and includes glitter particles.

12. The fishing lure set forth in claim 11 wherein said head portions each define outer surfaces and wherein said head portions each further include painted coloration on at least a portion of said outer surfaces.

13. A fishing lure comprising:
a fish hook having a shank;
a plurality of elongated elements forming loops about said shank and having extending ends;
a head formed of a pair of generally mirror image head portions; and
a quantity of adhesive material deposited upon said shank and said loops,
said fish hook shank, said loops and a portion of said elongated elements being captivated between said mirror image head portions such that said shank extends through said head and said extending ends of said elongated elements extend rearwardly beyond said head.

14. The fishing lure set forth in claim 13 wherein said head defines a generally rounded shape.
